(19) United States
(12) Patent Application Publication
(10) Pub. No.: US 2024/0302329 A1
(43) Pub. Date: Sep. 12, 2024

(54) CALIBRATING AN ULTRASOUND APPARATUS

(71) Applicant: DolphiTech AS, Gjovik (NO)

(72) Inventors: Eskil Skoglund, Gjovik (NO); Oyvind Syljuasen, Gjovik (NO); Fredrik Lingvall, Gjovik (NO); Tore Magne Skar, Gjovik (NO); Yngve Raudberget, Gjovik (NO)

(21) Appl. No.: 18/575,109

(22) PCT Filed: Jun. 28, 2022
(86) PCT No.: PCT/EP2022/067802

§ 371 Date: Dec. 28, 2023

(30) Foreign Application Priority Data
Jun. 30, 2021 (GB) 2109496.6

(51) Int. Cl. G01N 29/30; G01N 29/34; G01N 29/38

(52) U.S. Cl. CPC G01N 29/30; G01N 29/343; G01N 29/38; G01N 2291/023; G01N 2291/0289

(57) ABSTRACT

A method of calibrating an ultrasound apparatus for use in scanning an object to obtain subsurface information from the object, the ultrasound apparatus comprising an ultrasound transceiver for transmitting an ultrasound pulse towards the object and receiving a resultant ultrasound reflection signal from the object; the method comprising: determining a characteristic material in respect of the object to be scanned; selecting a feature of the characteristic material against which to calibrate the ultrasound apparatus; driving a pre-defined ultrasound pulse template into the characteristic material; receiving a resultant ultrasound reflection signal from the characteristic material; gating the received resultant ultrasound reflection signal based on the selected feature; and calibrating the ultrasound apparatus using the gated received resultant ultrasound reflection signal.

### CROSS-REFERENCE TO RELATED APPLICATIONS

The present application is the national stage entry of International Patent Application No. PCT/EP2022/067802, filed on Jun. 28, 2022, and claims priority to Application No. GB2109496.6, filed in the United Kingdom on Jun. 30, 2021, the disclosures of which are incorporated herein by reference thereto.

### FIELD OF THE INVENTION

This invention relates to calibrating an ultrasound apparatus for use in scanning an object to obtain subsurface information from the object. The ultrasound apparatus comprises an ultrasound transceiver for transmitting an ultrasound pulse towards the object and receiving a resultant ultrasound reflection signal from the object.

### BACKGROUND

An ultrasound apparatus typically includes a transducer module. The transducer module is for imaging an object, for instance for imaging structural features below an object's surface. The transducer module may be particularly useful for imaging sub-surface material defects such as delamination, debonding and flaking.

Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to generate images of the environment through which the sound wave travelled.

Ultrasound can be used to identify particular structural features in an object. For example, ultrasound may be used for non-destructive testing by detecting the size and position of flaws in a sample. There are a wide range of applications that can benefit from non-destructive testing, covering different materials, sample depths and types of structural feature, such as different layers in a laminate structure, impact damage, boreholes etc. Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled.

There is a need for a way to calibrate an ultrasound apparatus so that more accurate data can be obtained.

### SUMMARY

According to an aspect of the present invention, there is provided a method of calibrating an ultrasound apparatus for use in scanning an object to obtain subsurface information from the object, the ultrasound apparatus comprising an ultrasound transceiver for transmitting an ultrasound pulse towards the object and receiving a resultant ultrasound reflection signal from the object; the method comprising:
determining a characteristic material in respect of the object to be scanned;
selecting a feature of the characteristic material against which to calibrate the ultrasound apparatus;
driving a pre-defined ultrasound pulse template into the characteristic material;
receiving a resultant ultrasound reflection signal from the characteristic material;
gating the received resultant ultrasound reflection signal based on the selected feature; and
calibrating the ultrasound apparatus using the gated received resultant ultrasound reflection signal.

Determining the characteristic material may comprise determining a material having an acoustic impedance corresponding to an expected acoustic impedance of the object to be scanned, and selecting that determined material as the characteristic material.

Determining the characteristic material may comprise determining an expected thickness of the object to be scanned, and selecting a material having a thickness corresponding to the expected thickness as the characteristic material.

Determining the characteristic material may comprise determining an expected depth of a feature in the object to be scanned, and selecting a material having a thickness corresponding to the expected depth as the characteristic material.

Determining the characteristic material may comprise determining an expected thickness of the object to be scanned, and selecting a material having a particular thickness based on the relative speeds of ultrasound in the object to be scanned and in the characteristic material such that ultrasound propagation times through the expected thickness of the object and through the particular thickness of the characteristic material correspond. Determining the characteristic material may comprise determining an expected depth of a feature in the object to be scanned, and selecting a material having a particular thickness based on the relative speeds of ultrasound in the object to be scanned and in the characteristic material such that ultrasound propagation times through the expected depth of the object and through the particular thickness of the characteristic material correspond.

Selecting the feature of the characteristic material against which to calibrate the ultrasound apparatus may comprise selecting a subsurface feature of the characteristic material, and gating the received resultant ultrasound reflection signal comprises gating a subsurface reflection in the reflection signal.

Selecting the feature of the characteristic material against which to calibrate the ultrasound apparatus may comprise selecting a backwall of the characteristic material, and gating the received resultant ultrasound reflection signal comprises gating a backwall reflection in the reflection signal.

Selecting the feature of the characteristic material against which to calibrate the ultrasound apparatus may comprise selecting a front wall of the characteristic material, and gating the received resultant ultrasound reflection signal comprises gating a front wall reflection in the reflection signal.

The characteristic material may comprise a homogeneous material. The characteristic material may comprise Rexolite. The characteristic material may comprise plexiglass. The characteristic material may comprise a metal, for example aluminium. Suitably, where the characteristic material comprises Rexolite and/or plexiglass, selecting the feature of the characteristic material against which to calibrate the ultrasound apparatus may comprise selecting a backwall of the characteristic material, and gating the received resultant ultrasound reflection signal comprises gating a backwall reflection in the reflection signal. Where the characteristic material comprises Rexolite and/or plexiglass, selecting the feature of the characteristic material against which to calibrate the ultrasound apparatus may comprise selecting a front wall of the characteristic material, and gating the received resultant ultrasound reflection signal comprises gating a front wall reflection in the reflection signal. Suitably, where the characteristic material comprises a metal, selecting the feature of the characteristic material against which to calibrate the ultrasound apparatus may comprise selecting a front wall of the characteristic material, and gating the received resultant ultrasound reflection signal comprises gating a front wall reflection in the reflection signal. It can be more convenient to use a front wall reflection when transmitting ultrasound towards a metal, since typically less of the incident energy is coupled into the metal. Using the front wall reflection is therefore expected to lead to more accurate normalisation than using the backwall reflection for the metal.

The characteristic material may comprise a step wedge having multiple steps of different thicknesses, and selecting the material having a thickness corresponding to the expected thickness may comprise selecting a step of the multiple steps having a thickness closest to the expected thickness. The step wedge may comprise Rexolite or plexiglass.

Determining the characteristic material may comprise determining an expected type of subsurface feature of the object to be scanned, and selecting a material having a type of subsurface feature corresponding to the expected type of subsurface feature as the characteristic material.

Determining the characteristic material may comprise determining an expected subsurface feature of the object to be scanned, and selecting a material having a subsurface feature corresponding to the expected subsurface feature as the characteristic material.

The ultrasound transceiver may comprise a plurality of transducer elements, and driving the pre-defined ultrasound pulse template into the characteristic material may comprise driving the ultrasound transceiver to transmit the pulse, and calibrating the ultrasound apparatus may comprise selecting a subset of the plurality of transducer elements for use in scanning the object. The plurality of transducer elements may be provided across an area, and the subset of transducer elements may be provided away from a periphery of the area. The plurality of transducer elements may be provided across an area, and the subset of transducer elements may be provided centrally to the area. The plurality of transducer elements may form a 2D matrix array, and the subset of transducer elements may be located away from at least one edge of the array.

The received resultant ultrasound reflection signal may comprise respective components received at each respective transducer element of the plurality of transducer elements, and selecting the subset may comprise selecting transducer elements of the plurality of transducer elements at which an amplitude of the respective components is within a threshold standard deviation of the received resultant ultrasound reflection signal. The threshold standard deviation may be 60.

The received resultant ultrasound reflection signal may comprise respective components received at each respective transducer element of the plurality of transducer elements, and selecting the subset may comprise discarding transducer elements of the plurality of transducer elements at which an amplitude of the respective components is one of the x highest amplitudes or one of the y lowest amplitudes, where x and y are selected based on the distribution of amplitudes, and selecting the remainder as the subset of the plurality of transducer elements for use in scanning the object. x and y may be the same.

The method may comprise selecting one or more lines of data in a scan and normalising scan data using the selected one or more lines of data. The method may comprise normalising a tile of data other than the tile from which the selected one or more lines of data are taken. The method may comprise selecting the one or more lines of data based on a detected change in data values along the one or more lines of data. The detected change may comprise a change in one or more of intensity and gradient. The method may comprise selecting the one or more lines of data based on a comparison with an expected data profile.

The pre-defined ultrasound pulse template may comprise a pulse template consisting of two or more pulses of the same length. The pre-defined ultrasound pulse template may comprise a pulse template consisting of two or more pulses in which the length of one of those pulses is different from the length of at least another of those pulses. The pre-defined ultrasound pulse template may comprise a pulse template consisting of a single step.

According to another aspect of the present invention, there is provided an ultrasound apparatus for use in scanning an object to obtain subsurface information from the object, the ultrasound apparatus comprising:
an ultrasound transceiver for transmitting an ultrasound pulse towards the object and receiving a resultant ultrasound reflection signal from the object; and
a processor configured to:
   determine a characteristic material in respect of the object to be scanned;
   select a feature of the characteristic material against which to calibrate the ultrasound apparatus;
   drive a pre-defined ultrasound pulse template into the characteristic material;
   receive a resultant ultrasound reflection signal from the characteristic material;
   gate the received resultant ultrasound reflection signal based on the selected feature; and
   calibrate the ultrasound apparatus using the gated received resultant ultrasound reflection signal.

The ultrasound apparatus may comprise a user input device configured to receive a user input for selecting the feature of the characteristic material against which to calibrate the ultrasound apparatus.

Any one or more feature of any aspect above may be combined with any other aspect. These have not been written out in full here merely for the sake of brevity.

### BRIEF DESCRIPTION OF THE DRAWINGS

The present invention will now be described by way of example with reference to the accompanying drawings. In the drawings:

FIG. 1 shows a device for imaging an object;

FIG. 2 shows an example of a scanning system and an object;

FIG. 3 shows an example of the functional blocks of a scanning system;

FIGS. 4a to 4c show examples of an ultrasound signal and a corresponding match filter;

FIG. 5 shows examples of different pulse templates;

FIG. 6 shows an example of an imaging apparatus;

FIG. 7 shows an example of the functional blocks implemented by an FPGA;

FIG. 8 shows a block diagram of an ultrasound apparatus;

FIG. 9 shows a transducer surface illustrating a full aperture and a reduced aperture;

FIGS. 10 to 13 show images obtained from a transducer;

FIG. 14 is a flowchart of an illustrative method;

FIG. 15 shows the selection of lines in the results of a scan;

FIG. 16 shows a stitched image comprising a plurality of scan results;

FIG. 17 is a flowchart of an illustrative normalisation method;

FIG. 18a shows raw ultrasound data for a tile;

FIG. 18b shows the result of normalising the data of FIG. 18a;

FIG. 19a shows a stitched image; and

FIG. 19b shows the result of normalising the stitched image of FIG. 19a.

### DETAILED DESCRIPTION

An ultrasound apparatus can obtain information relating to the surface and subsurface features of an object to be scanned. The information obtained during the ultrasound scan can be processed and may subsequently be analysed or presented to a user, e.g. in a visual format. The accuracy of the analysis of the ultrasound data will depend on the accuracy with which the ultrasound apparatus obtains the information.

The present disclosure relates to a method of calibrating an ultrasound apparatus such that information obtained during an ultrasound scan by the ultrasound apparatus can be more accurate. Suitably, the ultrasound apparatus is for use in scanning an object to obtain subsurface information from the object, the ultrasound apparatus comprising an ultrasound transceiver for transmitting an ultrasound pulse towards the object and receiving a resultant ultrasound reflection signal from the object.

The method suitably involves determining a characteristic material in respect of the object to be scanned and selecting a feature of the characteristic material against which to calibrate the ultrasound apparatus. An ultrasound pulse template, e.g. a predefined ultrasound pulse template, can be driven by the ultrasound transceiver so as to be transmitted towards the characteristic material and coupled into the characteristic material. A reflection from the characteristic material is received at the ultrasound transceiver and is suitably gated in dependence on the selected feature. The ultrasound apparatus is then calibrated using the gated received signal.

Techniques in accordance with this approach will be described in more detail below.

A scanning system typically gathers information about structural features located different depths below the surface of an object. One way of obtaining this information is to transmit sound pulses at the object and detect sound that has passed through the object. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure the operator wants to look at is beneath the object's surface. It is therefore important that the information is imaged in such a way that the operator can evaluate the object's structure effectively and accurately.

Ultrasound transducers make use of a piezoelectric material, which is driven by electrical signals to cause the piezoelectric material to vibrate, generating the ultrasound signal. Conversely, when a sound signal is received, it causes the piezoelectric material to vibrate, generating electrical signals which can be detected.

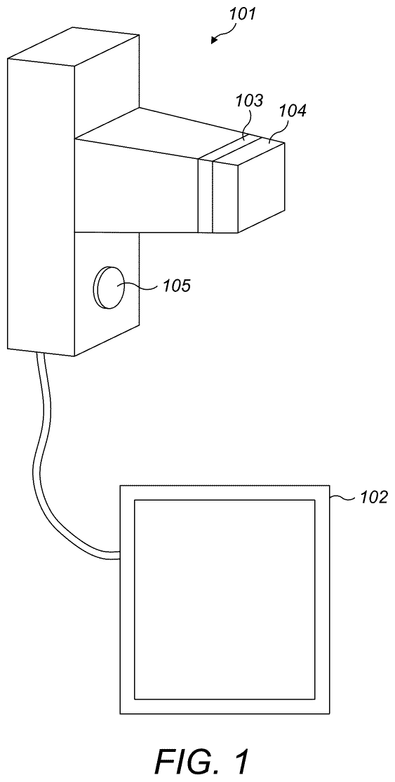

An example of a handheld device, such as a scanning system described herein, for imaging below the surface of an object is shown in FIG. 1. The device 101 could have an integrated display, but in this example it outputs images to a tablet computer 102. The connection with the tablet could be wired, as shown, or wireless. The device has a matrix array 103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus as illustrated comprises a coupling layer such as a dry coupling layer 104 for coupling ultrasound signals into the object. The coupling layer also delays the ultrasound signals to allow time for the transducers to switch from transmitting to receiving. The coupling layer need not be provided in all examples. The scanning system can comprise a coupling shoe attached to the front of the transducer.

The matrix array 103 is two dimensional so there is no need to move it across the object to obtain an image. A typical matrix array might be approximately 30 mm by 30 mm but the size and shape of the matrix array can be varied to suit the application. The device may be straightforwardly held against the object by an operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 105 or other user input device that the operator can use to change the pulse shape and corresponding filter. In other examples the dial need not be provided. Selection of the pulse shape and/or filter can be made in software. The most appropriate pulse shape may depend on the type of structural feature being imaged and where it is located in the object. The operator can view the object at different depths by manually adjusting the time-gating via the display. Having the apparatus output to a handheld display, such as the tablet 102, or to an integrated display, is advantageous because the operator can readily move the transducer over the object, or change the settings of the apparatus, depending on what is seen on the display and get instantaneous results. In other arrangements, the operator might have to walk between a non-handheld display (such as a PC) and the object to keep rescanning it every time a new setting or location on the object is to be tested.

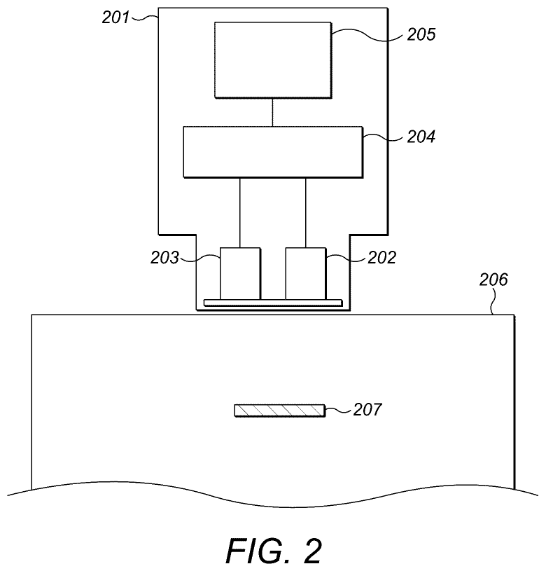

A scanning system for imaging structural features below the surface of an object is shown in FIG. 2. The apparatus, shown generally at 201, comprises a transmitter 202, a receiver 203, a signal processor 204 and an image generator 205. In some examples the transmitter and receiver may be implemented by an ultrasound transducer. The transmitter and receiver are shown next to each other in FIG. 2 for ease of illustration only. The transmitter 202 is suitably configured to transmit a sound pulse having a particular shape at the object to be imaged 206. The receiver 203 is suitably configured to receive reflections of transmitted sound pulses from the object. A sub-surface feature of the object is illustrated at 207.

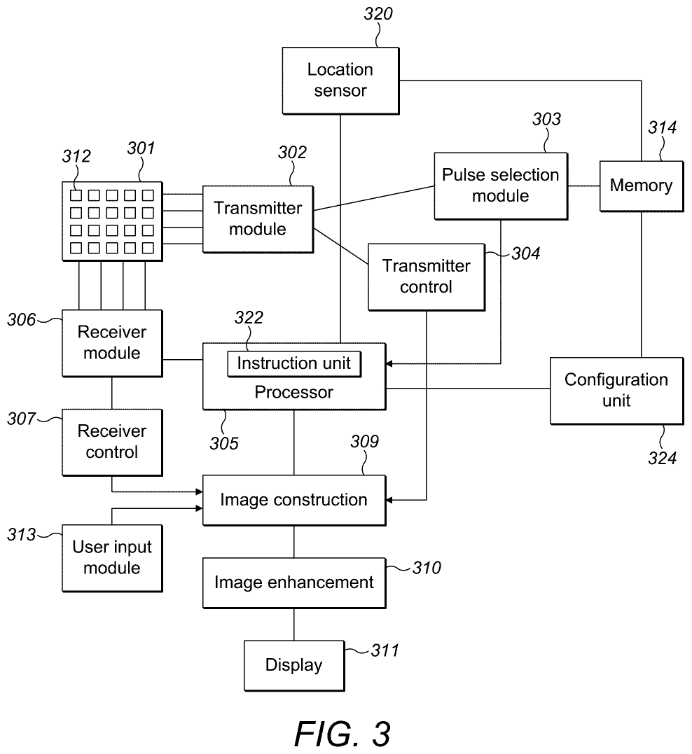

An example of the functional blocks comprised in one embodiment of the apparatus are shown in FIG. 3. In this example the transmitter and receiver are implemented by an ultrasound transducer 301, which comprises a matrix array of transducer elements 312. The transducer elements transmit and/or receive ultrasound waves. The matrix array may comprise a number of parallel, elongated electrodes arranged in an intersecting pattern; the intersections form the transducer elements. The transmitter electrodes are connected to the transmitter module 302, which supplies a pulse pattern with a particular shape to a particular electrode. The transmitter control 304 selects the transmitter electrodes to be activated. The number of transmitter electrodes that are activated at a given time instant may be varied. The transmitter electrodes may be activated in turn, either individually or in groups. Suitably the transmitter control causes the transmitter electrodes to transmit a series of sound pulses into the object, enabling the generated image to be continuously updated. The transmitter electrodes may also be controlled to transmit the pulses using a particular frequency. The frequency may be between 100 kHz and 30 MHZ, preferably it is between 0.5 MHz and 15 MHz and most preferably it is between 0.5 MHz and 10 MHz.

The receiver electrodes sense sound waves that are emitted from the object. These sound waves are reflections of the sound pulses that were transmitted into the object. The receiver module receives and amplifies these signals. The signals are sampled by an analogue-to-digital converter. The receiver control suitably controls the receiver electrodes to receive after the transmitter electrodes have transmitted. The apparatus may alternately transmit and receive. In one embodiment the electrodes may be capable of both transmitting and receiving, in which case the receiver and transmitter controls will switch the electrodes between their transmit and receive states. There is preferably some delay between the sound pulses being transmitted and their reflections being received at the apparatus. The apparatus may include a coupling layer (such as the dry coupling and/or as provided by the coupling shoe) to provide the delay needed for the electrodes to be switched from transmitting to receiving. Any delay may be compensated for when the relative depths are calculated. The coupling layer preferably provides low damping of the transmitted sound waves.

Each transducer element may correspond to a pixel in the image. In other words, each pixel may represent the signal received at one of the transducer elements. This need not be a one-to-one correspondence. A single transducer element may correspond to more than one pixel and vice-versa. Each image may represent the signals received from one pulse. It should be understood that “one” pulse will usually be transmitted by many different transducer elements. These versions of the “one” pulse might also be transmitted at different times, e.g. the matrix array could be configured to activate a “wave” of transducer elements by activating each line of the array in turn. This collection of transmitted pulses can still be considered to represent “one” pulse, however, as it is the reflections of that pulse that are used to generate a single image of the sample. The same is true of every pulse in a series of pulses used to generate a video stream of images of the sample.

The pulse selection module 303 selects the particular pulse shape to be transmitted. It may comprise a pulse generator, which supplies the transmitter module with an electronic pulse pattern that will be converted into ultrasonic pulses by the transducer. The pulse selection module may have access to a plurality of predefined pulse shapes stored in a memory 314. The pulse selection module may select the pulse shape to be transmitted automatically or based on user input. The shape of the pulse may be selected in dependence on the type of structural feature being imaged, its depth, material type etc. In general the pulse shape should be selected to optimise the information that can be gathered by the signal processor 305 and/or improved by the image enhancement module 310 in order to provide the operator with a quality image of the object.

The signal processor is suitably configured to analyse the received signal to find sections of the signal that represent reflections or echoes of the transmitted pulse. The pulses preferably have a known shape so that the signal processor is able to identify their reflections. The signal processing unit is suitably configured to recognise two or more reflections of a single transmitted pulse in the received signal. The signal processing unit is also configured to associate each reflected pulse with a relative depth, which could be, for example, the depth of the structural feature relative to transmitter and/or receiver, the depth of the structural feature relative the surface of the object, or the depth of the feature relative to another structural feature in the object. Normally the relative depth will be determined from the time-of-flight of the reflection (i.e. the time the reflection took to return to the apparatus) and so it represents the distance between the structural feature and the receive unit.

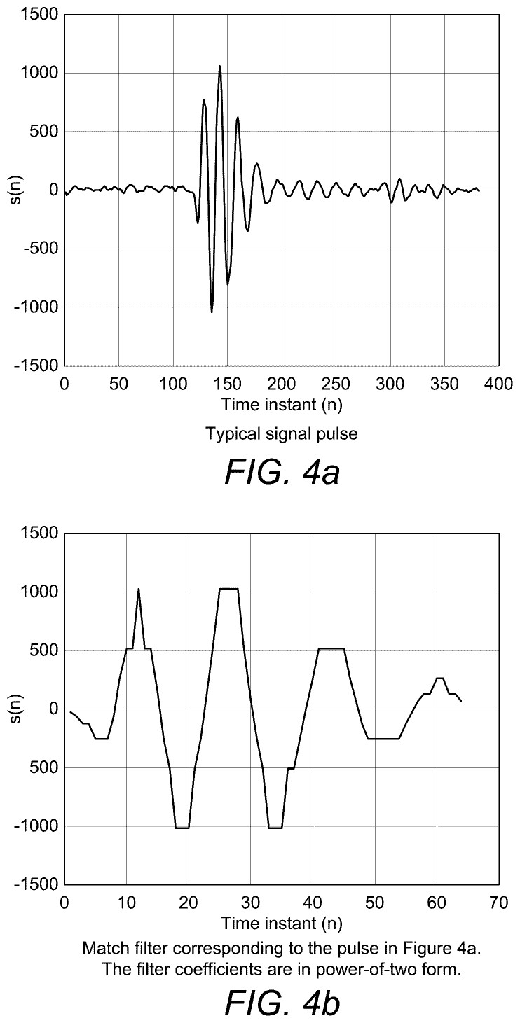

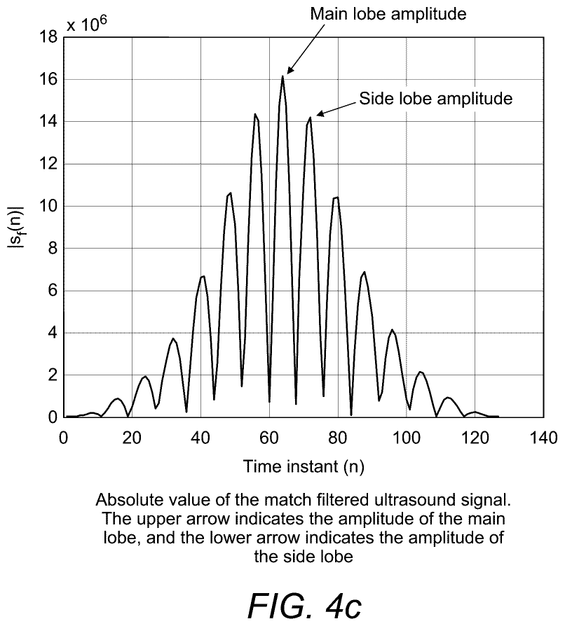

In one example a match filter that the signal processor uses to recognise reflections of a transmitted pulse may be selected to correspond to the selected pulse shape. Examples of an ultrasound signal s(n) and a corresponding match filter p(n) are shown in FIGS. 4a and 4b, respectively.

The aim is to select a pulse shape and corresponding match filter that will achieve a precise estimate of the time-of-flight of the reflected pulse, as this indicates the depth of the structural feature that reflected the pulse. The absolute values of the filtered time series (i.e. the absolute of the output of the match-filter) for ultrasound signal s(n) and corresponding match filter p(n) are shown in FIG. 4c. The signal processor estimates the time-of-flight as the time instant where the amplitude of the filtered time series is at a maximum. In this example, the time-of-flight estimate is at time instant 64. If the signal contains a lot of noise, however, this may cause other time instants to produce a higher value. The ideal output of the filter, to obtain the most precise time-of-flight estimate, would be a delta function with all samples having zero-amplitude apart from that at time instant 64 (for this case). Since this is not realisable in practice, the aim is to select pulse shapes and match filters to achieve a good margin between the amplitude of the main lobe and the amplitude of any side lobes.

The signal processor is preferably capable of recognising multiple peaks in each received signal. It may determine that a reflection has been received every time that the output of the match filter exceeds a predetermined threshold. It may identify a maximum amplitude for each acknowledged reflection.

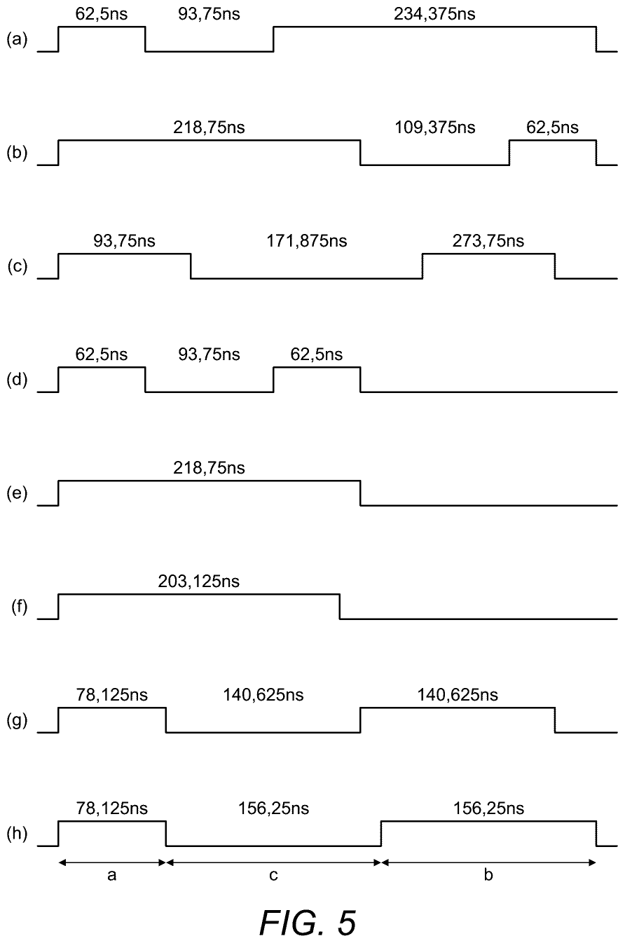

The information that is gathered by the sensing apparatus is likely to be more accurate the more accurately the reflections are detected by the detector. The exact shape of the transmitted ultrasound signals is, in practice, known only approximately to the detector because the pulse templates inevitably undergo some unquantifiable changes on being converted into an analogue signal and then output as an ultrasound signal. The inventors have found through practical experimentation that some pulse shapes are detected more accurately than others, and also that a particular pulse shape's performance can vary depending on the type of material in the sample and the structural feature that is being scanned. Experiments have also indicated that although some pulse shapes produce different outputs at the scanning apparatus, other pulse shapes produce outputs that are virtually indistinguishable from each other. Different pulse templates can consist of only one pulse, or more than one pulse, of various durations. It is also possible for a pulse template to consist of a single “step” from low-to-high or from high-to-low. A pulse may include both an increasing and a decreasing step. Examples of pulse templates are shown in FIG. 5.

In some implementations the apparatus may be configured to accumulate and average a number of successive samples in the incoming sample (e.g. 2 to 4) for smoothing and noise reduction before the filtering is performed. The signal processor is configured to filter the received signals using a match filter, as described above, to accurately determine when the reflected sound pulse was received at the apparatus. The signal processor then performs features extraction to capture the maximum amplitude of the filtered signal and the time at which that maximum amplitude occurs. The signal processor may also extract phase and energy information.

The apparatus may amplify the filtered signal before extracting the maximum amplitude and time-of-flight values. This may be done by the signal processor. The amplification steps might also be controlled by a different processor or FPGA. In one example the time corrected gain is an analogue amplification. This may compensate for any reduction in amplitude that is caused by the reflected pulse's journey back to the receiver. One way of doing this is to apply a time-corrected gain to each of the maximum amplitudes. The amplitude with which a sound pulse is reflected by a material is dependent on the qualities of that material (for example, its acoustic impedance). Time-corrected gain can (at least partly) restore the maximum amplitudes to the value they would have had when the pulse was actually reflected. The resulting image should then more accurately reflect the material properties of the structural feature that reflected the pulse. The resulting image should also more accurately reflect any differences between the material properties of the structural features in the object. The signal processor may be configured to adjust the filtered signal by a factor that is dependent on its time-of-flight.

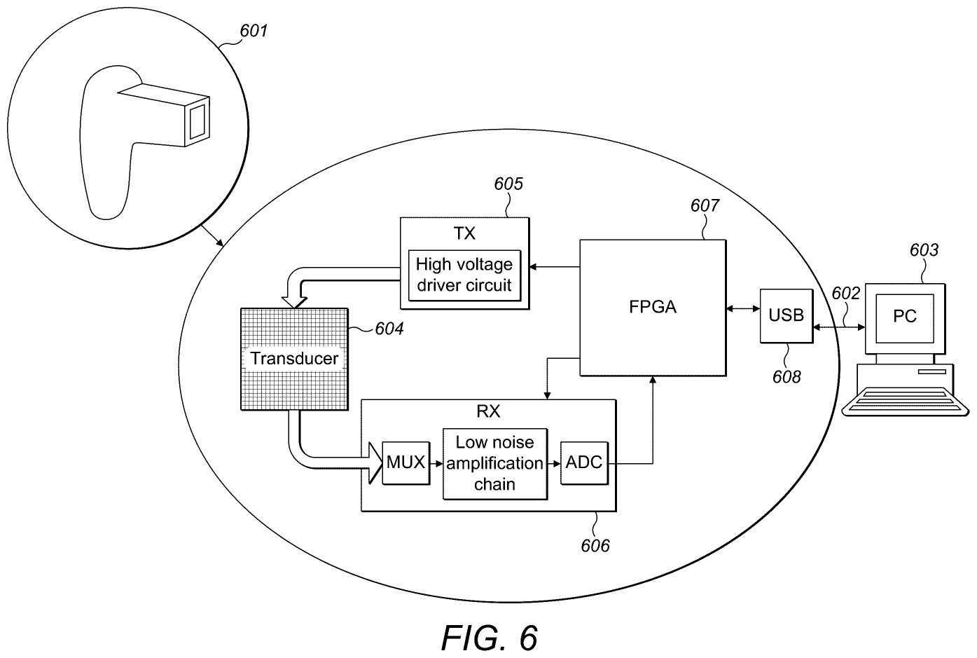

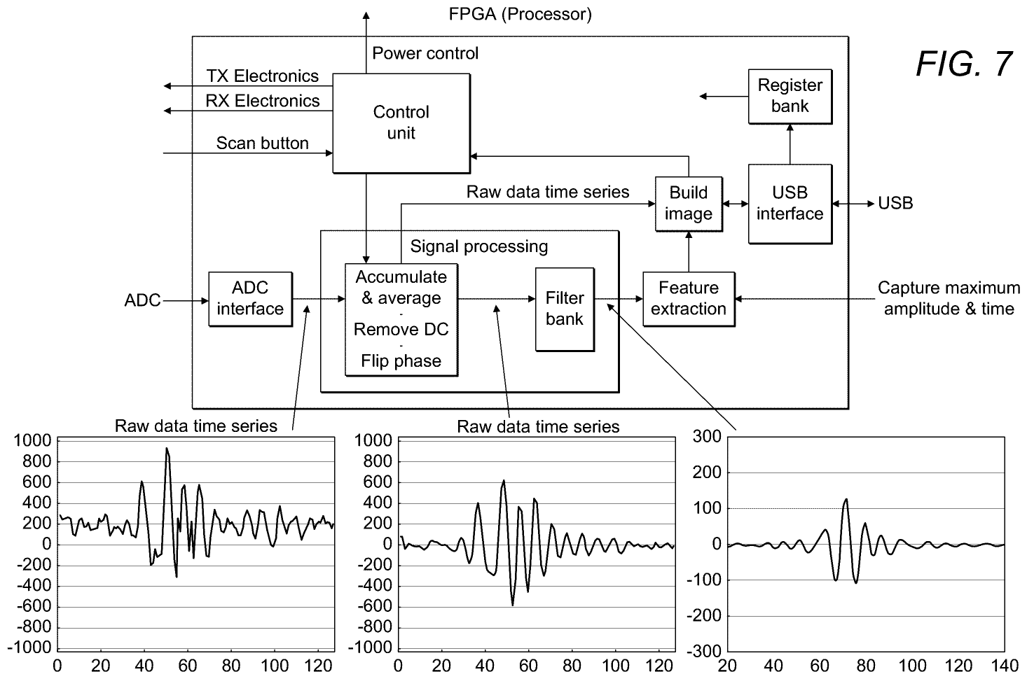

An example of a sound imaging apparatus is illustrated in FIG. 6. The apparatus comprises a handheld device, shown generally at 601, which is connected via a USB connection 602 to a PC 603. The connection might also be wireless. The handheld device comprises a transmitter unit 605, a receiver unit 606, an FPGA 607 and a USB connector 608. The USB connection connects the handheld device to a PC 603. The functional units comprised within the FPGA are shown in more detail in FIG. 7. The time series along the bottom of the figure show the transformation of the received data as it is processed.

An example of an ultrasound transceiver comprises a transducer laminate. The ultrasound transceiver comprises transmitter and receiver circuits that are respectively formed of copper deposited on a polyimide film. Each copper layer may form a series of electrodes. The electrodes might also be formed of other materials-gold, for example. A layer of piezoelectric material (e.g. PVDF) is sandwiched between the copper layers. This layer generates ultrasound signals when a high-voltage pulse train is sent out on the transmitter electrode, causing the piezoelectric layer to start vibrating and output an ultrasonic wave. In other examples the transducer might not comprise the adhesive or base film layers. The electrodes might be deposited directly on the piezoelectric layer.

The high-voltage pulse train is generated using a pulse template. Typically the pulse template is a digital signal that is then converted into the analogue, high voltage pulse train by the driver. This conversion may introduce small changes into the shape of the pulses. Also, the rise and fall times and transmit delay of the transmitter are usually specific to the transceiver and are largely unknown because of the unknown responsiveness of the piezoelectric layer to the high-voltage pulse train. These are two of the reasons why it is difficult to optimise the performance of the apparatus using the shape of the pulse template alone, because that pulse template will inevitably not be exactly what is transmitted as an ultrasound pulse.

In some examples the transmitter and receiver circuits comprise a plurality of elongated electrodes deposited in parallel lines on a flexible base layer. The transmitter and receiver circuits may be laminated together. They may be arranged so that their respective electrodes overlap at right angles to form an intersecting pattern. The intersections form an array of transducer elements.

The number of transmitter and receiver electrodes is scalable. Hence transducers can be designed of any desired size and shape. The electrode width is also scalable to adjust the amount of energy output per electrode. The electrode width can also be adjusted in dependence on the desired focus. The distance between the electrodes might also be varied. Generally it is preferred to have small gaps between neighbouring electrodes to maximise ultrasound energy by stimulating as large an area of the piezoelectric layer as possible. The thickness of the electrodes may be chosen to control factors such as frequency, energy and beam focus. The thickness of the base film may be chosen to control factors such as signal shape, frequency and energy. The PVDF thickness can also be adapted to change signal shape, frequency and energy (which are also dependent on the transmitting pulse shape). The delay line (e.g. dry coupling) thickness can be adapted to create a particular time lag between transmitting the ultrasound pulses and receiving reflections of them from the sample.

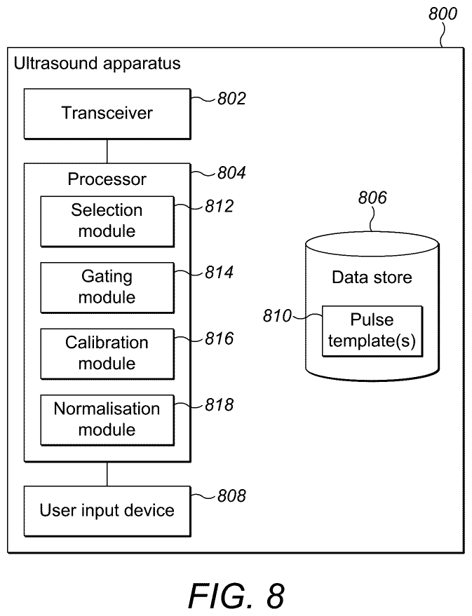

An ultrasound apparatus will now be described with reference to FIG. 8. The ultrasound apparatus is generally indicated at 800. The ultrasound apparatus comprises a transceiver 802 configured to transmit ultrasound signals and to receive reflections of those ultrasound signals for analysis. The ultrasound apparatus comprises a processor 804 coupled to the transceiver 802. The ultrasound apparatus 800 comprises a data store 806 coupled to the processor 804. A user input device 808 may optionally be provided and can be coupled to the processor 804.

The processor 804 can be configured to access one or more pulse templates 810 located at the data store 806. Conveniently the data store 806 is provided locally to the ultrasound apparatus 800. The data store 806 may be provided remote from the ultrasound apparatus and accessible thereto.

The ultrasound signals received at the transceiver 802 can be passed to the processor 804 for analysis. The processor 804 comprises a selection module 812, a gating module 814 and a calibration module 816.

The calibration can include a normalisation process. During the normalisation process, values are normalized to the range 0-255 to achieve good separation of colours when displayed. Normalisation may be performed by percentile normalisation. Under this scheme a low and a high percentile can be specified, where values belonging to the lower percentile are set to 0, values belonging to the high percentile are set to 255 and the range in between is scaled to cover [0, 255]. Another option is to set the colour focus directly by specifying two parameters, colorFocusStartFactor and colorFocusEndFactor, that define the start and end points of the range. The values below the start factor are set to 0, values above the end factor are set to 255 and the range in between is scaled to cover [0, 255]. Equivalently, in the calibration process values in the range [0, 1] can be used when thresholding, rather than using values in the range [0, 255]. Values in either range, [0, 1] or [0, 255], as appropriate, can then be scaled to a percentage value.

The selection module 812 is configured to select a feature of a characteristic material against which to calibrate the ultrasound apparatus. It can be advantageous to calibrate the ultrasound apparatus against a material that corresponds in at least one respect to an expected characteristic of an object to be scanned. For example, the characteristic material may have an acoustic impedance that corresponds to an expected acoustic impedance of the object to be scanned. The characteristic material may have a thickness that corresponds to an expected thickness of the object to be scanned. Alternatively the characteristic material may have a thickness that corresponds to an expected depth of a feature in the object to be scanned.

Suitably, determining the characteristic material comprises determining a material having an acoustic impedance corresponding to an expected acoustic impedance of the object to be scanned, and selecting that determined material as the characteristic material.

Suitably, determining the characteristic material comprises determining an expected thickness of the object to be scanned, and selecting a material having a thickness corresponding to the expected thickness as the characteristic material.

Suitably, determining the characteristic material comprises determining an expected depth of a feature in the object to be scanned, and selecting a material having a thickness corresponding to the expected depth as the characteristic material.

As ultrasound signals pass through a material they are absorbed and/or scattered such that the amplitude of the ultrasound signals generally decreases with increasing propagation distance through the material. Therefore, calibrating the ultrasound apparatus against a material with a characteristic corresponding to an expected characteristic of the object to be scanned enables the calibration to take account of propagation losses that might be incurred during the scan itself. This approach can therefore enable more accurate calibration to be performed.

Calibrating the ultrasound apparatus at a depth, or relative depth, that is similar to or the same as a depth of a feature of interest in the object or a thickness of the object can therefore increase the accuracy of the calibration process and thereby the accuracy of the ultrasound data obtained using the ultrasound apparatus to scan the object at that depth.

It can be advantageous to calibrate the ultrasound apparatus against a subsurface feature that corresponds to an expected subsurface feature in an object to be scanned. For example, if scanning for rivet damage it can be advantageous to calibrate the ultrasound apparatus against a subsurface feature corresponding to rivet damage and/or at a depth corresponding to a typical depth at which rivet damage occurs.

Suitably, therefore, selecting the feature of the characteristic material against which to calibrate the ultrasound apparatus comprises selecting a subsurface feature of the characteristic material, and gating the received resultant ultrasound reflection signal comprising gating a reflection corresponding to the subsurface feature in the reflection signal.

Preferably, selecting the feature of the characteristic material against which to calibrate the ultrasound apparatus comprises selecting a backwall of the characteristic material, and gating the received resultant ultrasound reflection signal comprises gating a backwall reflection in the reflection signal. When calibrating the ultrasound apparatus against a backwall of the characteristic material the ultrasound transmitted by the ultrasound apparatus is suitably coupled into the characteristic material via a couplant such as water or gel. Providing the couplant between the scanning surface of the ultrasound apparatus and the object has the effect of “filling in” small gaps and defects that result from a surface roughness of the scanning surface.

Thus, basing the calibration of the ultrasound apparatus on a backwall echo in the received ultrasound signals can have the advantageous effect of reducing or avoiding undesirable effects on the calibration that might otherwise be caused by the surface roughness of the scanning surface.

This is especially relevant where Aqualene is provided at the ultrasound apparatus, e.g. where Aqualene forms at least part of a delay line between an ultrasound transducer and the object to be scanned. This is because Aqualene typically has a variable thickness (landscape roughness) over the scanning area that can create a variable amplitude in a reflected signal when measuring against air. Thus, calibrating the ultrasound apparatus against the characteristic material, such as against the backwall echo of the characteristic material, can avoid this variable amplitude being included in the calibration data and can therefore improve the quality of a subsequent scan obtained using the calibrated ultrasound apparatus.

Further, as discussed herein, it is advantageous to use the backwall peak in a set of received ultrasound signals when calibrating the ultrasound apparatus since this also enables account to be taken of dispersion or other propagation losses within the thickness of the material.

Selecting the feature of the characteristic material against which to calibrate the ultrasound apparatus can comprise selecting a front wall of the characteristic material, and gating the received resultant ultrasound reflection signal can comprise gating a front wall reflection in the reflection signal.

Where a feature of interest in an object to be scanned includes bubbles in water or gel, it can be advantageous to select a front wall echo to use in the calibration process. In such situations it has been found that using a front wall echo in the calibration process can give better control over coupling into the material which can enhance the resultant data obtained.

Preferably, the characteristic material comprises a homogeneous material. Use of a homogeneous material in the calibration process can avoid inhomogeneities causing local variance in amplitude that might deleteriously affect the calibration. Thus the use of a homogeneous material can improve the consistency and accuracy of data obtained using the calibrated ultrasound apparatus.

The characteristic material can comprise a step wedge having multiple steps of different thicknesses. Selecting the material having a thickness corresponding to the expected thickness can therefore comprise selecting a step of the multiple steps that has a thickness closest to the expected thickness. Thus for a thickness of the characteristic material to correspond to an expected thickness (or expected depth of a feature of interest) in an object to be scanned it is not necessary for the thickness to precisely match the expected thickness (or expected depth). Rather, it has been found that it is sufficient if the thickness is within a small range of the expected thickness or expected depth. For example, the thickness of the characteristic material can be within 3 mm of the expected thickness or expected depth. Suitably, the thickness is within 2 mm of the expected thickness or expected depth. More preferably, the thickness is within 1 mm of the expected thickness or expected depth.

The characteristic material can comprise Rexolite. The characteristic material can comprise plexiglass. Suitably the step wedge comprises Rexolite. The step wedge may comprise plexiglass.

Rexolite and plexiglass have been found to be suitable materials for use as the characteristic material due to the homogeneous structure and the ability to obtain highly planar front and rear surfaces. These characteristics enable these materials to function well as the characteristic material in the calibration process.

As discussed above, the characteristic material with which to calibrate the ultrasound apparatus can be of the same or a similar thickness to the object to be scanned, or of the same or a similar thickness to the depth of a feature of interest in the object to be scanned. This need not be the case. Where the characteristic material is the same material, or largely the same material, as the object to be scanned, then this approach is likely to be highly effective. However, where the characteristic material and the object comprise materials for which the speed of sound at ultrasonic frequencies differs, then the accuracy of the calibration process can be reduced. The reduction in accuracy is likely to depend on the difference between the speed of the ultrasound signals in each material. Generally, as the difference between the speed of ultrasound in each material becomes greater, the accuracy of the calibration will reduce. The calibration may still be useful, however. Despite a relatively lower accuracy, the calibration process is still likely to result in an ultrasound apparatus that is relatively more accurate that one for which no such calibration process has been carried out.

Where the speed of ultrasound differs between the characteristic material and the object to be scanned, calibration accuracy can be maintained or increased by taking this speed of ultrasound into account. The timing of the reflected signals will be important. Thus, where the speed of ultrasound in a material is greater, the thickness can be correspondingly greater. As an example, consider an approximately 4 mm thick sample of CFRP as the object to be scanned. Where it is desired to use Rexolite as the characteristic material for calibration purposes, a comparison of the speed of ultrasound in CFRP and Rexolite can be made. The speed of sound in CFRP is approximately 3070 m/s. The speed of sound in Rexolite is approximately 2350 m/s. For comparison, the speed of sound in Aqualene 320 is approximately 1600 m/s. The speed of ultrasound in CFRP is higher than that in Rexolite. Therefore, for reflected signals to have a similar propagation time in Rexolite, a relatively thinner Rexolite sample should be used, for example an approximately 3 mm thick sample, as the characteristic material. The required thicknesses can be calculated based on the relative speeds of ultrasound, as would be understood by the skilled person.

Thus, when determining the thickness of the characteristic material, for example in a step wedge comprising different thicknesses, the selection can be made based on the relative speeds of ultrasound in the characteristic material and the object to be scanned. In one implementation, a lookup table may be accessed, where the lookup table comprises data relating to equivalent thicknesses of different materials, e.g. thicknesses for which propagation time of ultrasound of a given frequency, or a given frequency range, is the same. For example, the lookup table can comprise data indicating that x mm of Rexolite is equivalent to y mm of a particular metal, and/or z mm of another material, at the given frequency or range of frequencies. The materials for which data is to be included in the lookup table can be selected from a group comprising common materials for objects to undergo ultrasound testing. This group can comprise materials such as CFRP, GFRP, glass, metals, brass, copper, gold, titanium, aluminium, steel, iron, lead, polymers, silicone, nylon, rubber, different laminate structures, and so on.

Determining the characteristic material suitably comprises determining an expected type of subsurface feature of the object to be scanned, and selecting a material having a type of subsurface feature corresponding to the expected type of subsurface feature as the characteristic material.

Determining the characteristic material may comprise determining an expected subsurface feature of the object to be scanned, and selecting a material having a subsurface feature corresponding to the expected subsurface feature as the characteristic material. This approach is particularly beneficial where the material is homogeneous. Non-homogeneous materials, such as carbon fibre reinforced polymer (CFRP) and glass fibre reinforced polymer (GFRP), can lead to additional reflections within the material that might appear to be ‘random’ reflections. These additional reflections can reduce the accuracy of the calibration process.

This selection of the characteristic material having a corresponding feature or type of feature to an expected feature or type of feature in the object to be scanned enables the calibration process to be performed in a way that is specific to the expected feature or type of feature. Thus, the calibration process can be tailored to enhance the accuracy with which such a feature or type of feature can be detected.

For example, where it is desired to analyse a laminate structure having a layer boundary at a given depth below the surface it can be useful to calibrate the ultrasound apparatus on a characteristic material comprising a feature akin to the laminate boundary at or close to the given depth. Where the characteristic material comprises layers that have the same or similar acoustic properties as expected in the object to be scanned, the calibration process can take account of the likely proportion of ultrasound energy reflected at boundaries within the object. Hence, when using such a calibrated ultrasound apparatus to scan an object having such layers and boundaries between layers the resulting data can be more accurate.

The ultrasound transceiver can comprise a plurality of transducer elements. For example, the transducer can comprise an array such as a 2D or matrix array of transducer elements. The transducer elements in the matrix array can be arranged in a square array. The matrix array can be a 128×128 element array. Multiple elements can be grouped together to act as an effective element, to assist in pulse transmission, for example to enable a higher amount of energy to be generated at each effective element compared to each individual element. In one example, a group of 2×2 transducer elements can be grouped into one effective element. Where the matrix array comprises a 128×128 element array, the array will therefore comprise an effective matrix array of 64×64 elements. In the following it is not necessary to distinguish between transducer elements and effective elements, since the principles discussed apply to either situation. Thus, the plurality of transducer elements can comprise a plurality of individual transducer elements or a plurality of effective transducer elements (groups of individual transducer elements).

Driving the pre-defined ultrasound pulse template into the characteristic material comprises driving the transducer to transmit the pulse. Each of the plurality of transducer elements may be driven to transmit the pulse. Calibrating the ultrasound apparatus suitably comprises selecting a subset of the plurality of transducer elements for use in scanning the object. In this way it is possible to select which of the transducer elements are to be used when scanning the object. This approach enables transducer elements which do not respond correctly to be ignored. That is, the data obtained from such transducer elements can simply be discarded.

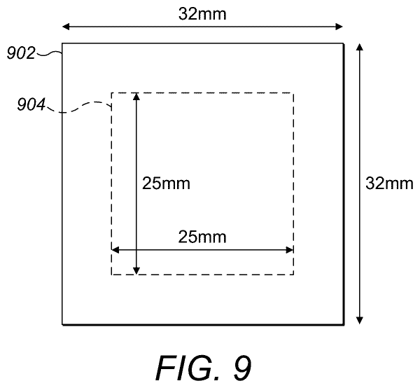

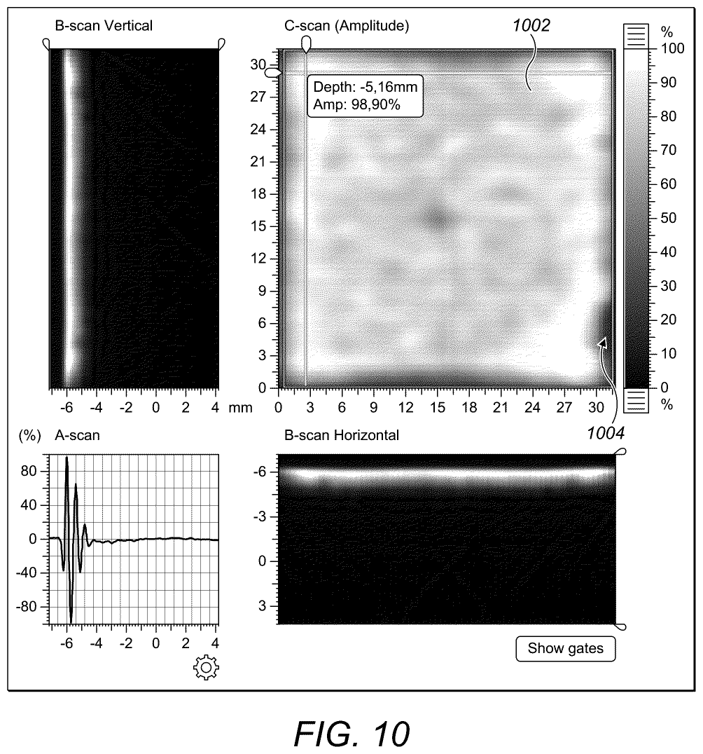

Reference is now made to FIG. 9 which illustrates a transducer module in plan view. The transducer has a transducer surface 902 comprising a matrix array with a size of 32×32 mm. This 32×32 mm matrix array represents the full aperture of the transducer, and can comprise the 128×128 element array. FIG. 10 shows a representation 1002 of the response from the 128×128 matrix array across the full 32×32 mm aperture when the transducer is fired into air, with no normalisation. Edge effects are clearly visible, as indicated by arrow 1004, along all four edges of the representation 1002, in particular towards the lower right corner (in the orientation of the image in FIG. 10). The range of amplitudes in the representation shown in FIG. 10 is 12-100% with a mean of 86% and a standard deviation of +15%.

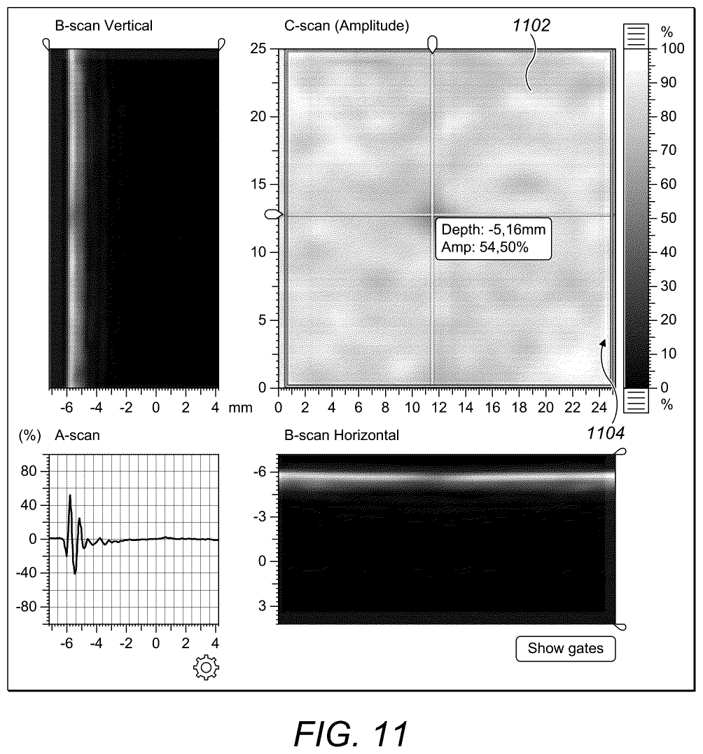

FIG. 11 shows a representation 1102 of the response from a matrix array across a reduced aperture compared to the full aperture configuration of FIG. 10. The reduced aperture of FIG. 11 is a 25×25 mm aperture comprising a 100×100 transducer element matrix array (illustrated in dashed lines in FIG. 9 at 904). To reduce the effect of the edge effects visible in FIG. 10, the reduced aperture of FIG. 11 is selected from a central region of the full aperture of FIG. 10. The range of amplitudes in the representation shown in FIG. 11 is 60-100% with a mean of 91% and a standard deviation of +5%. It will therefore be readily appreciated that the amplitude variations across the reduced aperture are significantly lower than the amplitude variations across the full aperture. Further, the edge effects which are visible in the full aperture representation of FIG. 10 are not present to any significant degree in the reduced aperture representation of FIG. 11. This is because the reduced aperture represents a central portion of the full aperture and so the edges of the full aperture representation are omitted in the reduced aperture representation.

It is not necessary in all examples for the reduced aperture to be central relative to the full aperture. For example where edge effects are not present, or are not the most significant cause of amplitude variations, within a full aperture image, the reduced aperture can be selected from the full aperture so as to avoid an area or areas that cause the greatest amplitude variations. Identifying the reduced aperture in this way enables the reduced aperture to avoid problematic amplitude variations and so improve the consistency across the reduced aperture image. This can lead to an increased accuracy in the calibration process and an increased accuracy in data captured using the calibrated ultrasound apparatus.

Suitably, the plurality of transducer elements are provided across an area, and the subset of transducer elements is provided away from a periphery of the area, for example towards a centre of the area.

The reduced aperture area need not be a contiguous area within the full aperture area. In some cases it is appropriate to consider the response of groups of transducer elements within the matrix array, or even of individual transducer elements within the matrix array.

The received resultant ultrasound reflection signal can comprise respective components received at each respective transducer element of the plurality of transducer elements. Selecting the subset can comprise selecting transducer elements of the plurality of transducer elements at which an amplitude of the respective components is within a threshold standard deviation of the received resultant ultrasound reflection signal (e.g. of all the components of the reflection signal). Suitably, the threshold standard deviation is 60. Other threshold standard deviations may be selected as appropriate in a particular scenario.

Selecting the subset so as to avoid those transducer elements whose amplitudes fall outside the threshold standard deviation effectively involves discarding the responses of the transducer elements that do not form part of the subset.

Selecting transducer elements to form the subset based on the threshold standard deviation is one approach that can be taken. Another approach is to look at the amplitude values themselves and to select transducer elements whose amplitude values do not fall within a given range of the maximum and/or minimum amplitude values.

For example, the transducer elements at which the highest ten amplitudes are detected can be omitted from the subset. In another example, the transducer elements at which the lowest ten amplitudes are detected can be omitted from the subset. In a further example, the transducer elements at which the highest ten amplitudes are detected and the transducer elements at which the lowest ten amplitudes are detected can be omitted from the subset. It has been determined that even omitting such relatively few transducer elements from the subset can have a significant impact on the overall amplitude variation within the subset (within the reduced aperture image).

The choice of the number ten in the above example is not critical. What is important is that the outliers are discarded and those transducer elements at which the most consistent amplitude values are obtained are retained within the subset. Further the number of amplitudes at the top of the range that are discarded need not be the same as the number of amplitudes at the bottom of the range that are discarded. The particular numbers of amplitudes at the top of the range and at the bottom of the range that are to be discarded can be selected in dependence on the characteristic behaviour of the transducer elements within the matrix array.

It is also possible to select the subset based on the proportion or percentage amplitude obtained at each transducer element. For example, transducer elements at which the highest 2% of the amplitudes are obtained can be discarded. Similarly, transducer elements at which the lowest 2% of the amplitudes are obtained can be discarded. As above, with the number of amplitudes at the top and bottom of the range that are discarded, the percentage given in this example is not critical. Nor does the percentage of the amplitude at the top of the range to be discarded need to match the percentage of the amplitude at the bottom of the range to be discarded. What is important is that the percentage selected should enable outliers, e.g. at least a majority of the outliers, to be discarded thus enhancing the consistency of the amplitudes in respect of the transducer elements selected to form part of the subset.

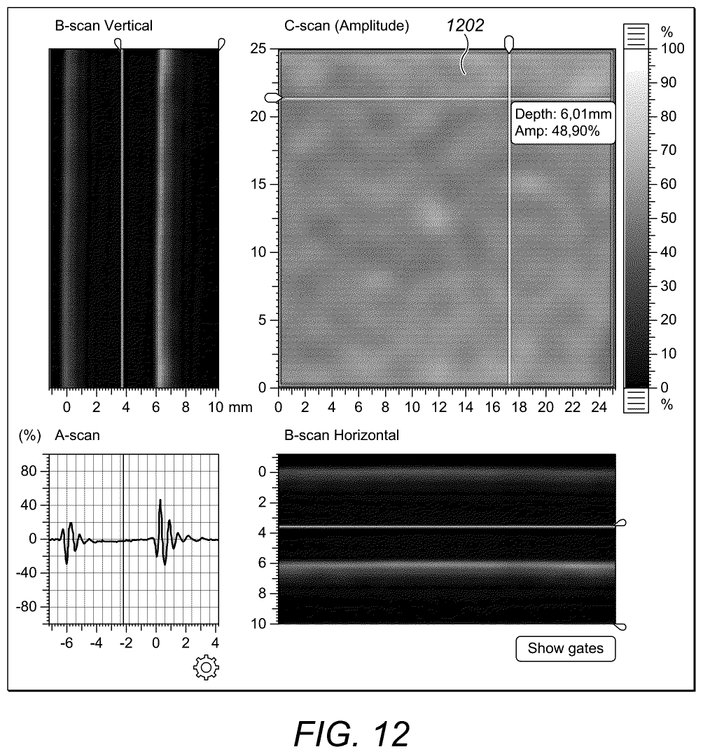

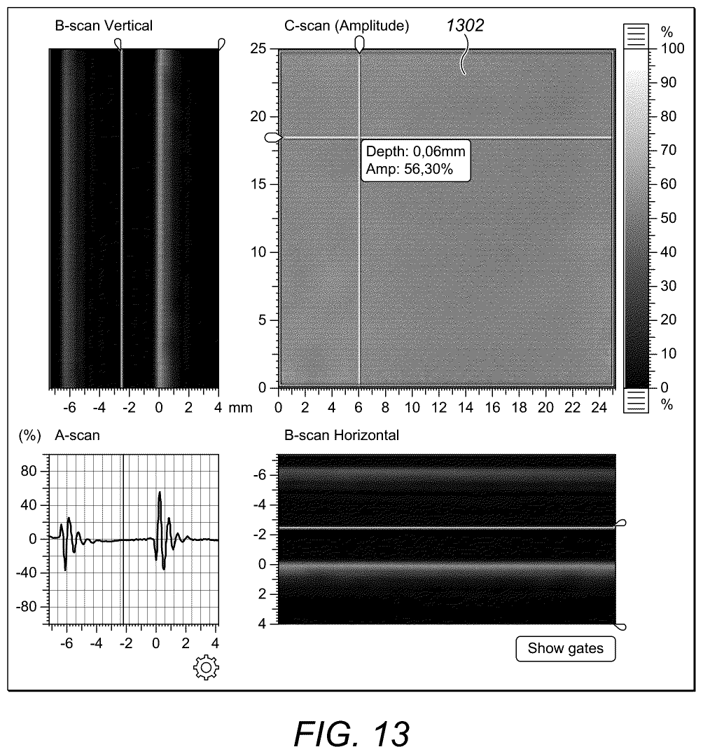

A comparison between results obtained using an ultrasound apparatus calibrated against air with those obtained using an ultrasound apparatus calibrated against a backwall of a plexiglass material is given in FIGS. 12 and 13. FIG. 12 illustrates the amplitude response of an ultrasound apparatus calibrated by firing it against air and then scanning a 6 mm plexiglass sample. The resultant image obtained 1202, using a 25×25 mm reduced aperture, shows noticeable amplitude variations across the plexiglass sample.

FIG. 13 illustrates the amplitude response of an ultrasound apparatus calibrated by firing it against a 6 mm plexiglass sample and using the backwall echo to calibrate the transducer. The calibrated ultrasound apparatus was then used to scan a 6 mm plexiglass sample (different to the calibration sample). The resultant image obtained 1302 shows consistent amplitude across the reduced 25×25 mm aperture, indicating a smooth profile of the scanned plexiglass sample.

The contrast between the images 1202 and 1302 is distinct. Image 1202 comprises amplitude variations that are not present in the scanned plexiglass sample (or in image 1302). Rather, these variations have been inadvertently introduced by virtue of calibrating the transducer by firing it into air. As discussed elsewhere herein, firing into air can mean that microsurface roughness of a front surface of the transducer module affect the calibration process. That is, roughness of a surface forming a boundary, and hence a reflecting surface, between a front of the transducer module and air, can affect the calibration process. The techniques discussed herein of calibrating the ultrasound apparatus against a characteristic material show an improved result, as indicated in image 1302.

An ultrasound apparatus calibrated in accordance with the techniques discussed herein can be used to obtain more accurate, or more representative, data relating to an object to be scanned. The obtained data can highlight amplitude variations such as those due to thickness or density variations within the object to be scanned with a greater resolution than previously possible.

Thus an ultrasound apparatus calibrated in accordance with the present techniques lends itself to investigations which may not previously have been possible using an ultrasound apparatus, or a 2D array transducer ultrasound apparatus. For instance, the calibrated ultrasound apparatus can be used in investigating porosity of objects. Changes in the porosity of a scanned object will be shown as variations in the amplitude of a scan obtained using the calibrated ultrasound apparatus. Using a selection tool, such as on a computer at which the ultrasound results are processed, an area within such a scan can be selected and a measure of the porosity can be provided for that area. For example, a porosity measurement calculated for each amplitude value within that area can be averaged to provide an overall porosity measurement for the selected area. The selected areas can be large or small within the image. The areas need not be contiguous with one another in the image.

The porosity measurement is suitably a relative porosity measurement. That is, the porosity measurement can indicate a relative level of porosity compared to a reference value or a reference point in the image. The reference point in the image is suitably selectable by a user.

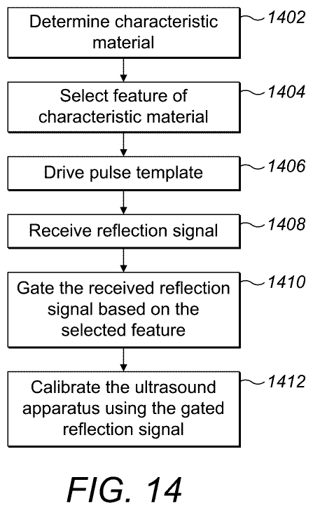

A flow chart illustrating a method of calibrating an ultrasound apparatus will now be described with reference to FIG. 14. A characteristic material is determined in respect of an object to be scanned 1402. Subsequently, a feature of the characteristic material against which the ultrasound apparatus is to be calibrated is selected 1404. A pulse template is driven into the characteristic material 1406. Suitably the pulse template is a pre-defined pulse template, such as one of a plurality of pre-defined pulse templates. The pulse template or the plurality of pulse templates are suitably stored at or in a way accessible to the ultrasound apparatus. Reflections of the transmitted ultrasound pulse are received from the characteristic material 1408. The received reflections are gated based on the selected feature 1410. The ultrasound apparatus may then be calibrated using the gated received signal 1412.

The ultrasound signals received-either at the full aperture (represented at 902 in FIG. 9) or a reduced aperture (e.g. as represented at 904 in FIG. 9, but the reduced aperture could be, as discussed elsewhere herein, of a different shape and/or size, and/or non-contiguous, and/or non-centrally located)—can be used for a normalisation process. This normalisation process can be additional to the calibration process described elsewhere herein or it can be used separately from that calibration process. In this normalisation process, data received across a subset of lines of elements can be used to normalise data received across all the lines of elements in the data under consideration (which will be reduced from the full set of all physical lines where a reduced aperture is used).

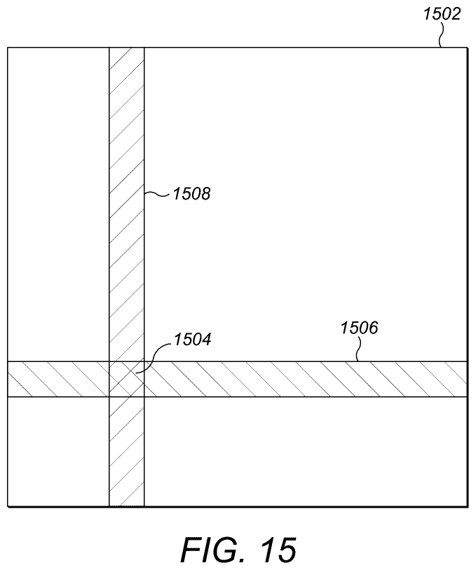

With reference to FIG. 15, a receive aperture is represented at 1502. Within the data set received at this receive aperture, a horizontal or vertical line can be selected that has no or few defects. A line is suitably selected on the basis of having as few defects as possible. In this way, the normalisation will be based on the reflections propagating through the material itself, rather than reflections caused by defects or other possible inhomogeneities.

Whilst it would be possible to normalise the data set based on data received over the whole area, this would be computationally more expensive than performing the normalisation based on a subset of the data, and would be likely to take longer. Thus, basing the normalisation on a subset of data can save time and processing power needed.

Suitably, the line is selected based on the data in that line indicating a change in attenuation along the line. Selecting a line with such a change in attenuation enables that attenuation to be accounted for in the normalisation process. This can thereby result in more accurate normalised data.

The line can be selected manually, for example by a user viewing the data received on a display. The user may for example move a pointer on the display, such as cross-hairs, over a desired line for selection and indicate by way of a button click or similar that that line is to be selected. The user can indicate whether the line to be selected is a horizontal or vertical line. Alternatively, the line might automatically be selected as a horizontal or vertical line based on pre-set information such as user preference. The user can suitably click on (or otherwise indicate) a single element 1504 in the 2D scan data, and the horizontal 1506 or vertical 1508 line can be taken as the respective line including that element.

The line can be selected automatically. The ultrasound apparatus, e.g. the processor at the ultrasound apparatus, can select the line. The processor 804 suitably comprises a normalisation module 818 configured to analyse the data and to select the line in dependence on that analysis. The processor is suitably configured to select a line based on how the data along that line changes. The change can relate to intensity and/or gradient. The processor can select the line for which the data changes most gradually or in a manner closest to a linear change. This way of selecting the line can reduce the chance that the processor selects a line with a defect or other inhomogeneity, since such defects and/or inhomogeneities are likely to produce a rapid change in data along the line, such as a spike when the defect is encountered. The processor can select the line for which the data best matches an expected profile. In analysing the match, the processer can use a least-squares comparison, or other known technique, as would be apparent to the skilled person. The expected profile can be based on one or more previous profiles (e.g. an average of previous profiles) obtained from a similar object or a simulated profile or a combination of these.

Whether or not automatic selection of a line is appropriate can be determined from an analysis of a single line, multiple lines (e.g. 10 lines or 20 lines), a single tile, or multiple tiles. Where multiple lines or tiles are analysed, the lines or tiles analysed can relate to a common part of the scanned object. If, on this analysis, there is a level of change greater than a threshold level of change, it can be determined that automatic selection of a line is to be carried out, and that the normalisation process should be performed. Where there is a level of change lower than a threshold level of change, it can be determined either that automatic selection of a line is not appropriate (there may be too little change to enable the automatic selection process to identify the best line to use for normalisation) or that normalisation is not needed.

The processor can be configured to select one or more lines for which the change in data is below a further threshold change. Where the data changes gradually along a line, the further threshold change suitably comprises a given percentage change along the line, e.g. a 15% change. This value is not critical, and it will be understood that this threshold percentage will vary in different materials where the ultrasound response is expected to differ, for example where many scattering centres are present which are likely to increase the rate of change of data along the lines in the scan. In those situations, a higher further threshold change is likely to be more appropriate. The use of the further threshold change can help avoid lines with defects (causing relatively greater change in the data along that line) being used for normalisation.

The processor can be configured to select one or more lines for which the match with an expected profile is within a threshold ‘distance’.

Where the processor selects more than one line, e.g. according to the data changing along the line at a rate less than the further threshold change and/or according to the data for that line being within a threshold distance of an expected profile, a single line can be selected for normalisation in one of several ways. The multiple identified lines can be indicated to a user, and the user can select a line from the multiple identified lines. The multiple identified lines can be analysed according to another metric to select the best of the identified lines for the normalisation process. This metric can, for example, comprise a measure of quality of data in those lines, such as a signal to noise ratio (SNR). Where the SNR is greater, the relevant line can be weighted more highly for selection than lines with lower SNRs. The metric can comprise a weighting indicating a preference for a particular method of identifying a line. For instance, where the preference is for lines identified by matching an expected profile, such lines can be selected instead of lines that were identified in other ways. The best of these lines (e.g. the line with the best match) can then be selected as the line to use in the normalisation process.

Where no lines meet the selection criteria, the ultrasound apparatus suitably indicates to the user that another scan should be performed. Thus, where data is of insufficient quality (e.g. if the transducer does not couple well with the object being scanned) normalisation need not be carried out using poor data, but an indication is provided that another scan should be performed to try and obtain higher quality data.

Whilst the normalisation process here is described in the context of a single line, it is possible to carry out the normalisation process based on two or more lines. These two or more lines may be next to one another. In this case, the additional one or more lines can be selected to be those lines adjacent the selected line, such as one or two lines to either side of the selected line. Alternatively, the two or more lines can be selected by considering the two or more lines together in the initial analysis. In this way, data from multiple lines can be combined together when analysing the data, so as to increase the SNR of that data or to reduce the influence of outlying data points.

The selected line (or lines) is then used in the normalisation process to normalise the data received. A selected horizontal line is used to normalise each horizontal line in the data. A selected vertical line is used to normalise each vertical line in the data.

The selected line can be used to normalise data in additional scans as well as the scan in which the selected line is located. For instance, in a stitched image (see FIG. 16), multiple individual scans or tiles can be provided. As illustrated, the stitched image 1602 comprises six tiles 1604, 1606, 1608, 1610, 1612, 1614. A first tile 1604 of the stitched image 1602 corresponds to the scan illustrated in FIG. 15. As can be seen, a selection can be made of a single element 1504 to indicate a horizontal 1506 or vertical 1508 line. The selected line can be used to normalise the remaining tiles 1606, 1608, 1610, 1612, 1614 in the stitched image 1602 in addition to normalising the first tile 1604.

This approach is particularly suitable where the stitched image 1602 comprises scans relating to corresponding material or parts. Where the same part is being scanned, it is highly likely that a similar normalisation process will result in more accurate data. Using the line selected for another tile rather than selecting a new line each time can save time and processing power.

Thus, in the case of the vertical line 1508 being selected in the first tile 1604, that vertical line can be used to normalise the additional tiles in the same row 1606, 1608. The vertical line 1508 may also be used to normalise the additional tiles 1610, 1612, 1614 in other rows (in the illustration, only one other row is shown). Alternatively, a new line can be selected for each row. Thus, another element 1616 can be selected in a tile 1610 in the second row, leading to the selection of a horizontal 1618 or vertical 1620 line in that tile 1610. Suitably, the vertical line 1620 in this tile 1610 is selected for normalising that tile 1610 as well as the other tiles in that row 1612, 1614. This approach, of selecting a line in each tile in a row, can assist in increasing the accuracy of the normalisation process.

Whilst the above example discusses selecting vertical lines and using those selected vertical lines to normalise tiles in the same row, it is possible to instead select horizontal lines and use those selected horizontal lines to normalise tiles in the relevant columns. The process is not restricted to using vertical lines to normalise tiles in the same row or horizontal lines to normalise tiles in the same columns. Selected vertical line(s) can be used to normalise tiles in the same column as the tile(s) in which the selected vertical line(s) are located. Similarly, selected horizontal line(s) can be used to normalise tiles in the same row as the tile(s) in which the selected horizontal line(s) are located.

Suitably, the processor is configured to analyse the stitched image 1602 (or the constituent parts of the stitched image, namely the tiles 1604, 1606, 1608, 1610, 1612, 1614) to identify multiple parts within the image (where the parts might have differing ultrasound responses). For each identified part, a line selection process can be carried out, and that selected line can be used to normalise each tile (or subset of each tile) that corresponds to the identified part. In this way, the normalisation process can use a different normalisation for each part being scanned. This can improve the accuracy of the normalisation. Note here that ‘part’ does not necessarily denote a separate physical part being scanned, but can be a portion of the scanned object with a different ultrasound response.

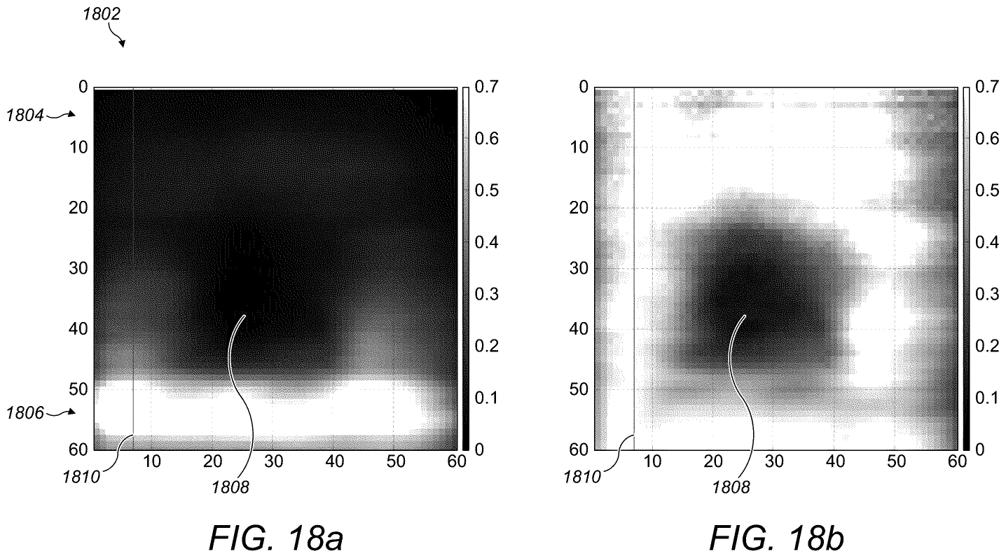

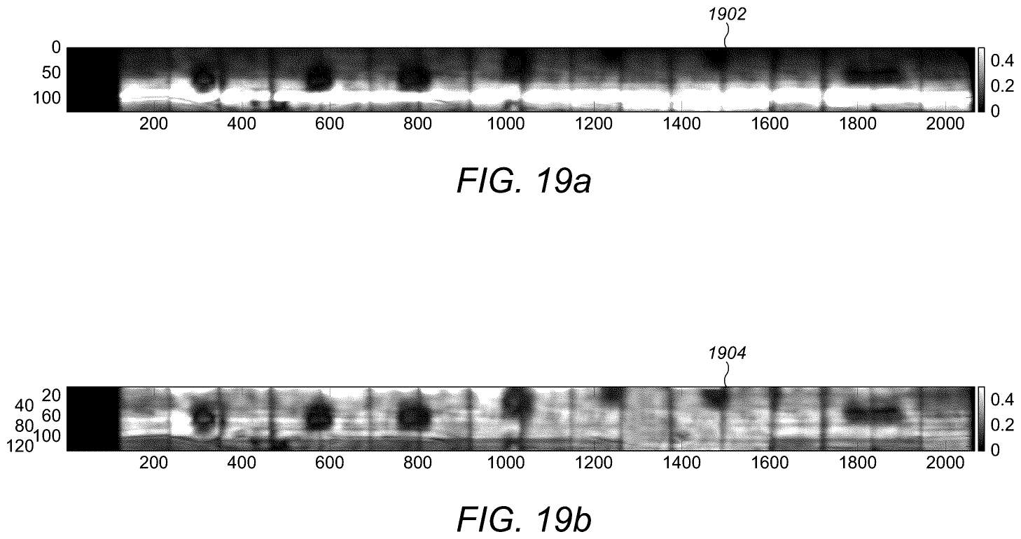

A further illustration of the techniques described herein is given in FIGS. 18a, 18b, 19a and 19b. FIG. 18a shows raw data 1802 for a single tile. The tile of data shows C-scan data for a through-transmission ultrasound (TTU) scan of a pi-joint. There is an apparent gradient in the image from lower values (darker; towards the top of the image; indicated generally at 1804) to higher values (lighter; towards the bottom of the image; indicated generally at 1806). A darker feature 1808 central to the image can be seen, but it is not very clear.

A vertical line 1810 has been selected for normalising the data shown in the tile. The selected line is visible towards the left of the tile, at the 7th pixel in from the left. It can be seen that the selected line 1810 avoids the central feature 1808.

FIG. 18b shows the result of normalising each vertical line of data in the tile of FIG. 18a using the selected vertical line of data 1810. The vertical gradient within the tile is mostly if not completely removed, and the feature 1808 central to the tile is more clearly visible as a result. Thus, this normalisation has cleaned up the image of FIG. 18a. Subsequent analysis of the normalised image of FIG. 18b is therefore much more likely to provide accurate results than analysing the image of FIG. 18a.

This normalisation can be extended, as discussed herein, to adjacent tiles in a stitched image. FIG. 19a shows a stitched image 1902. The stitched image 1902 has been generated by stitching together tiles from scans along one direction (shown as the x-direction in FIG. 19a). In the illustrated stitched image 1902, in areas of overlap between adjacent tiles of data, the data has been averaged. FIG. 19a shows the result of normalising the stitched image 1902 with a selected line of data from one of the tiles. The vertical gradient visible in the stitched image 1902 of FIG. 19a has been mostly if not completely removed in the normalised stitched image 1904 of FIG. 19b. Thus, the normalisation has cleaned up the stitched image 1902. It can be seen that the normalised stitched image 1904 has a greater image clarity across all of the tiles than the stitched image 1902. Thus, the normalisation process described herein, in which a single line of data can be used to normalise multiple tiles of data, shows very good results. These good results are achievable at a lower processing time and power than typical normalisation processes, since it is not necessary to normalise the data of each tile based on all of the received data points.

In the present techniques, the normalisation process can be carried out after the data has been captured. This means that the normalisation process does not affect the speed at which the data capture occurs. It also means that the normalisation process can be carried out differently, depending on the feature of interest in a particular scan or group of scans. Thus, the present techniques can improve the flexibility of use of the system.

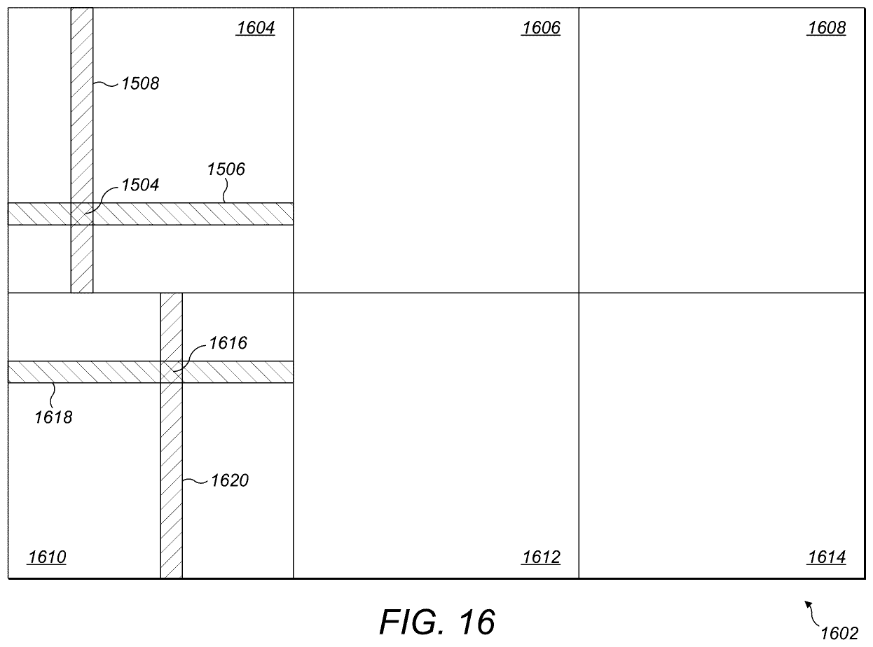

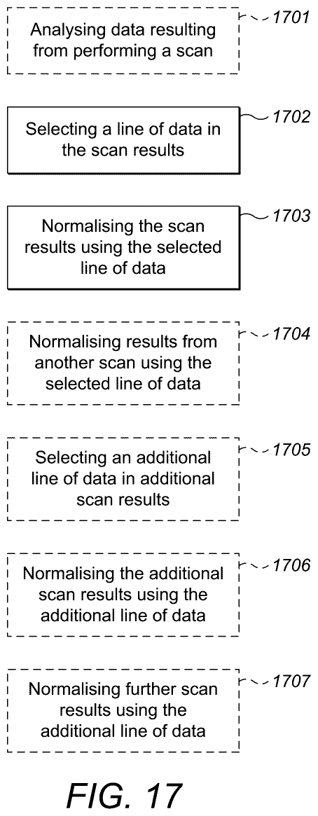

A flow chart illustrating a method of normalising data captured using an ultrasound apparatus will now be described with reference to FIG. 17. As an optional step, data obtained from a scan using the ultrasound apparatus is analysed 1701. This analysis can aid in the automatic selection of one or more lines of data, as described above. One or more lines of data in the scan results are selected 1702. This selection can follow step 1701 where the selection is performed automatically, or it can be a step of user-selection, where no previous analysis (as described above in relation to the selection of the one or more lines) by the processor of the scan results is needed. At 1703, normalisation is carried out on the scan results using the selected one or more lines of data. The method can continue in the optional step of normalising results from another scan (e.g. in another tile of a stitched image) using the selected one or more lines of data 1704. Further, as another optional step, an additional one or more lines of data is selected from additional scan results 1705. This additional one or more lines of data is used to normalise the additional scan results 1706. The additional one or more lines of data can optionally also be used to normalise further scan results 1707.

The apparatus and methods described herein are particularly suitable for detecting debonding and delamination in composite materials such as carbon-fibre-reinforced polymer (CFRP). This is important for aircraft maintenance. It can also be used to detect flaking around rivet holes, which can act as a stress concentrator. The apparatus is particularly useful for detecting corrosion, welding, cracks, and so on, in metals or metallic structures. The apparatus is particularly suitable for applications where it is desired to image a small area of a much larger component. The apparatus is lightweight, portable and easy to use. It can readily be carried by hand by an operator to be placed where required on the object.

The structures shown in the figures herein are intended to correspond to a number of functional blocks in an apparatus. This is for illustrative purposes only. The functional blocks illustrated in the figures represent the different functions that the apparatus is configured to perform; they are not intended to define a strict division between physical components in the apparatus. The performance of some functions may be split across a number of different physical components. One particular component may perform a number of different functions. The figures are not intended to define a strict division between different parts of hardware on a chip or between different programs, procedures or functions in software. The functions may be performed in hardware or software or a combination of the two. Any such software is preferably stored on a non-transient computer readable medium, such as a memory (RAM, cache, FLASH, ROM, hard disk etc.) or other storage means (USB stick, FLASH, ROM, CD, disk etc). The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device. Any of the functional units described herein might be implemented as part of the cloud.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method of calibrating an ultrasound apparatus for use in scanning an object to obtain subsurface information from the object, the ultrasound apparatus comprising an ultrasound transceiver for transmitting an ultrasound pulse towards the object and receiving a resultant ultrasound reflection signal from the object; the method comprising:
determining a characteristic material in respect of the object to be scanned;
selecting a feature of the characteristic material against which to calibrate the ultrasound apparatus;
driving a pre-defined ultrasound pulse template into the characteristic material;
receiving a resultant ultrasound reflection signal from the characteristic material;
gating the received resultant ultrasound reflection signal based on the selected feature; and
calibrating the ultrasound apparatus using the gated received resultant ultrasound reflection signal.

2. A method according to claim 1, in which determining the characteristic material comprises determining a material having an acoustic impedance corresponding to an expected acoustic impedance of the object to be scanned, and selecting that determined material as the characteristic material.

3. A method according to claim 1, in which determining the characteristic material comprises:
(i) determining an expected thickness of the object to be scanned, and selecting a material having a thickness corresponding to the expected thickness as the characteristic material; or
determining an expected depth of a feature in the object to be scanned, and selecting a material having a thickness corresponding to the expected depth as the characteristic material;
or
(ii) determining an expected thickness of the object to be scanned, and selecting a material having a particular thickness based on the relative speeds of ultrasound in the object to be scanned and in the characteristic material such that ultrasound propagation times through the expected thickness of the object and through the particular thickness of the characteristic material correspond; or
determining an expected depth of a feature in the object to be scanned, and selecting a material having a particular thickness based on the relative speeds of ultrasound in the object to be scanned and in the characteristic material such that ultrasound propagation times through the expected depth of the object and through the particular thickness of the characteristic material correspond.

4. (canceled)

5. A method according to claim 1, in which selecting the feature of the characteristic material against which to calibrate the ultrasound apparatus comprises:
(i) selecting a subsurface feature of the characteristic material, and gating the received resultant ultrasound reflection signal comprises gating a subsurface reflection in the reflection signal; and/or
selecting a backwall of the characteristic material, and gating the received resultant ultrasound reflection signal comprises gating a backwall reflection in the reflection signal;
or
(ii) selecting a front wall of the characteristic material, and gating the received resultant ultrasound reflection signal comprises gating a front wall reflection in the reflection signal.

6. (canceled)

7. A method according to claim 1, in which the characteristic material comprises a homogeneous material.

8. A method according to claim 3, in which the characteristic material comprises a step wedge having multiple steps of different thicknesses, and selecting the material having a thickness corresponding to the expected thickness comprises selecting a step of the multiple steps having a thickness closest to the expected thickness.

9. (canceled)

10. A method according to claim 1, in which determining the characteristic material comprises:
determining an expected type of subsurface feature of the object to be scanned, and selecting a material having a type of subsurface feature corresponding to the expected type of subsurface feature as the characteristic material; and/or
determining an expected subsurface feature of the object to be scanned, and selecting a material having a subsurface feature corresponding to the expected subsurface feature as the characteristic material.

11. A method according to claim 1, in which the ultrasound transceiver comprises a plurality of transducer elements, and driving the pre-defined ultrasound pulse template into the characteristic material comprises driving the ultrasound transceiver to transmit the pulse, and calibrating the ultrasound apparatus comprises selecting a subset of the plurality of transducer elements for use in scanning the object.

12. A method according to claim 11, in which the plurality of transducer elements are provided across an area, and the subset of transducer elements comprises:
transducer elements of the plurality of transducer elements provided away from a periphery of the area; and/or
transducer elements of the plurality of transducer elements provided centrally to the area.

13. (canceled)

14. A method according to claim 11, in which the received resultant ultrasound reflection signal comprises respective components received at each respective transducer element of the plurality of transducer elements, and selecting the subset comprises selecting transducer elements of the plurality of transducer elements at which an amplitude of the respective components is within a threshold standard deviation of the received resultant ultrasound reflection signal.

15. A method according to claim 11, in which the received resultant ultrasound reflection signal comprises respective components received at each respective transducer element of the plurality of transducer elements, and selecting the subset comprises discarding transducer elements of the plurality of transducer elements at which an amplitude of the respective components is one of the x highest amplitudes or one of the y lowest amplitudes, where x and y are selected based on the distribution of amplitudes, and selecting the remainder as the subset of the plurality of transducer elements for use in scanning the object.

16. A method according to claim 1, comprising selecting one or more lines of data in a scan and normalising scan data using the selected one or more lines of data.

17. A method according to claim 16, comprising normalising a tile of data other than the tile from which the selected one or more lines of data are taken.

18. A method according to claim 16, comprising selecting the one or more lines of data based on a detected change in data values along the one or more lines of data.

19. A method according to claim 18, in which the detected change comprises a change in one or more of intensity and gradient.

20. A method according to any of claim 19, comprising selecting the one or more lines of data based on a comparison with an expected data profile.

21. A method as claimed in claim 1, in which the pre-defined ultrasound pulse template comprises:
a pulse template consisting of two or more pulses of the same length; and/or
a pulse template consisting of two or more pulses in which the length of one of those pulses is different from the length of at least another of those pulses.

22. (canceled)

23. A method as claimed in any of claim 20, in which the pre-defined ultrasound pulse template comprises a pulse template consisting of a single step.

24. An ultrasound apparatus for use in scanning an object to obtain subsurface information from the object, the ultrasound apparatus comprising:
an ultrasound transceiver for transmitting an ultrasound pulse towards the object and receiving a resultant ultrasound reflection signal from the object; and
a processor configured to:
determine a characteristic material in respect of the object to be scanned;
select a feature of the characteristic material against which to calibrate the ultrasound apparatus;
drive a pre-defined ultrasound pulse template into the characteristic material;
receive a resultant ultrasound reflection signal from the characteristic material;
gate the received resultant ultrasound reflection signal based on the selected feature; and
calibrate the ultrasound apparatus using the gated received resultant ultrasound reflection signal.

25. An ultrasound apparatus according to claim 24, comprising a user input device configured to receive a user input for selecting the feature of the characteristic material against which to calibrate the ultrasound apparatus.
